(19) United States
(12) Patent Application Publication
(10) Pub. No.: US 2014/0068621 A1
(43) Pub. Date: Mar. 6, 2014

(54) DYNAMIC STORAGE-AWARE JOB SCHEDULING

(71) Applicants: Sriram Sitaraman, Sunnyvale, CA (US); Qionglin Fu, Belmont, CA (US)

(72) Inventors: Sriram Sitaraman, Sunnyvale, CA (US); Qionglin Fu, Belmont, CA (US)

(21) Appl. No.: 13/598,724

(22) Filed: Aug. 30, 2012

(51) Int. Cl. G06F 9/46

(52) U.S. Cl. 718/102

(57) ABSTRACT

Computer-implemented techniques for executing jobs on parallel processors using dynamic storage-aware job scheduling are disclosed. A network storage system is accessed along with a scheduling queue of pending job processes. The networked storage system is polled to determine the status of members of the storage system. These members comprise storage devices and storage shares. A database is created of metrics describing the status of the members of the networked storage system. Job processes are then dispatched to the networked storage system based on this database of metrics.

### FIELD OF INVENTION

This application relates generally to job scheduling and more particularly to dynamic storage-aware job scheduling.

### BACKGROUND

Networked storage is a common commodity in modern, large-scale computing environments. For example, in grid computing, fifty thousand or more CPUs may share common networked storage. The shared storage systems are designed to handle only a specific number of storage and communications requests simultaneously. When that storage system capacity is exceeded, storage performance—and thus by extension computational performance—decreases. Although the problem of limited storage and communications capacity applies to any storage system, the difficulty is particularly acute for disk-based systems featuring multiple processors which access the same physical disk. Such disk-based storage systems are typically comprised of a large number of drives. These drives can be Serial ATA (SATA) disks, serial attached SCSI (SAS) disks, or solid-state drives (SSD). The objective of such storage systems is to provide flexible, easily-accessible shared storage to a large number and a wide variety of computing platforms and computing tasks.

A wide range of computing applications may use the networked storage system simultaneously. As a result, storage performance tuning is necessary in order for specific computational tasks to function at maximum efficiency. Further, the centralized structure inherent to such a networked storage system often causes a computational bottleneck attributable to a variety of factors. Among this variety of factors, two contribute significantly to such computational bottlenecks: the limited resources of current storage systems (i.e. network bandwidth, storage input/output bandwidth, storage configuration, and amount of local memory), and the limited scaling abilities of current storage architectures. Centralized storage also suffers when certain compute jobs use all available resources, thus starving other jobs of required storage bandwidth. Also, the unpredictability of resource requirements of compute jobs in NFS-heavy or large scale grids, the hiding of resource requirements from the grid manager, and the lack of an NFS paradigm for quality of service (QoS) further limit the usability of such systems. These limiting factors often lead to the overloading of storage devices and the eventual stalling of both compute jobs and the cores on which those jobs execute.

### SUMMARY

Scheduling of storage jobs on networked storage systems has a significant and direct impact on the overall computational performance of large multiprocessor systems. Effective scheduling distributes jobs in a manner which reduces—and ideally eliminates—scheduling bottlenecks which result from some storage devices being overloaded while others remain underutilized or idle. A computer-implemented method for dynamic storage-aware job scheduling is disclosed comprising: accessing a network storage system; accessing a scheduling queue of pending job processes which use the network storage system; polling the network storage system to determine status of members of the network storage system; creating a database of metrics describing the status of the members of the network storage system; and dispatching job processes to the network storage system based on the database of metrics describing the status of the members of the network storage system.

The dispatching of job processes may be further based on storage requirements of the job processes. The method may further comprise scheduling a subset of the job processes. The scheduling may be based on job properties from the subset of the job processes. The scheduling may be based on the database of the metrics. The scheduling may comprise dispatching a job process with lower priority. The job process with lower priority may have different storage requirements from job processes with higher priority. The method may further comprise maintaining threshold values for the members of the network storage system. The threshold values may be maintained in the database of the metrics. The threshold value from the threshold values may be specific to a certain member of the network storage system. The threshold values may include one or more of a group including storage limit, interface bandwidth limit, number of job processes accessing a storage member. The method may further comprise updating the threshold values based on a job process length. The method may further comprise updating the threshold values based on a status-polling interval. The scheduling may be accomplished by a grid scheduler. The method may further comprise assigning tags to threshold values to represent boundary metrics. The tags may include data comprising CPU percentage utilization of a network share. A rules engine may be used in the scheduling by a grid scheduler. The method may further comprise evaluating a job process in the scheduling queue for storage related parameters. The method may further comprise evaluating a job process in the scheduling queue for storage dependencies. The method may further comprise updating an order within the scheduling queue based at least one of storage related parameters and storage dependencies. The method may further comprise sending a job process to a processor. The method may further comprise evaluating a job process at a time the job process is added to the scheduling queue. The method may further comprise evaluating a job process when the job process is ready to be dispatched for execution. The method may further comprise deleting a job process from the scheduling queue based on storage requirements of the job process. The method may further comprise re-queuing the job process which was deleted. The network storage system may comprise at least one of storage devices and storage shares. The database of metrics may include index-enabled values. The polling may further comprise collecting parameters comprising CPU capabilities, memory capacity, maximum performance rate, or percentage utilization.

In embodiments, a computer system with job scheduling may comprise: a memory which stores instructions; one or more processors coupled to the memory wherein the one or more processors are configured to: access a network storage system; access a scheduling queue of pending job processes which use the network storage system; poll the network storage system to determine status of members of the network storage system; create a database of metrics describing the status of the members of the network storage system; and dispatch job processes to the network storage system based on the database of metrics describing the status of the members of the network storage system. In some embodiments, a computer program product embodied in a non-transitory computer readable medium for job scheduling may comprise: code for accessing a network storage system; code for accessing a scheduling queue of pending job processes which use the network storage system; code for polling the network storage system to determine status of members of the network storage system; code for creating a database of metrics describing the status of the members of the network storage system; and code for dispatching job processes to the network storage system based on the database of metrics describing the status of the members of the network storage system

Various features, aspects, and advantages of various embodiments will become more apparent from the following further description.

### BRIEF DESCRIPTION OF THE DRAWINGS

The following detailed description of certain embodiments may be understood by reference to the following figures wherein:

FIG. 1 is a flow diagram for storage-aware job scheduling.

FIG. 2 is a flow diagram for metric and threshold usage.

FIG. 3 is a flow diagram for job evaluation.

FIG. 4 is a diagram showing large-scale storage system.

FIG. 5 is a diagram showing resource usage policy.

FIG. 6 is a flow illustrating scheduling.

FIG. 7 is a system diagram for dynamic storage-aware job scheduling.

### DETAILED DESCRIPTION

Networked storage systems are commonly implemented to handle the myriad storage requirements typical of modern, highly parallel, highly distributed, large-scale computing environments. For example, grid-computing systems may comprise fifty thousand or more CPUs, each of which accesses and utilizes a substantial, common, networked storage. Such networked storage systems are designed to handle only a specific number of storage and communications requests simultaneously. Storage requests become problematic if multiple processors access the same physical storage device or share simultaneously, and if communication is limited by network and storage system bandwidth. When that capacity is exceeded, storage performance—and therefore computational performance—decreases. Although limited capacity applies to any storage system, the difficulty is particularly acute for disk-based systems featuring multiple processors which access the same physical disk. Such disk-based storage systems are typically comprised of a large number of drives. These drives can be Serial ATA (SATA) disks, serial attached SCSI (SAS) disks, or solid-state drives (SSD). Irrespective of the types of drives used, the critical objective of networked storage systems is to provide flexible, easily accessible, shared storage to a large number and wide variety of computing platforms.

A wide range of computing applications may use such networked storage system simultaneously. A storage performance tuning is necessary in order for a variety of specific computational tasks to function at maximum efficiency. Further, the centralized structure inherent to such a networked storage system often causes a computational bottleneck attributable to several factors including the limited resources of storage systems (i.e. network bandwidth, storage input/output bandwidth, storage configuration, and amount of local memory), and the limited scaling abilities of storage architectures. Centralized storage also suffers when certain compute jobs consume all available resources, thus starving other jobs of their required resources. Also, the unpredictability of resource requirements of compute jobs in NFS-heavy or large scale grids, the hiding of resource requirements from the grid manager, and the lack of an NFS paradigm for quality of service (QoS) further limit the usability of such systems. These limiting factors often lead to overloading of critical storage devices and the eventual stalling of both compute jobs and the cores on which those jobs execute.

Networked storage devices have a common design comprising controllers and disks. Network storage shares typically span multiple physical disks, and a single controller hosts multiple storage shares—although the number of shares is limited by performance or capacity. Based on years of requests by storage customers, the provisioning model has advanced in an evolutionary manner, currently allocating storage in small blocks. This allocation scheme permits acceptable distribution of a given customer's storage requirements across multiple devices. Such distribution reduces failure rates, but imposes multi-tenancy on any given storage device. Multi-tenancy offers the advantages of efficiency, lower system cost, and accessibility, but it also introduces performance unpredictability.

Networked storage devices are optimized for storage capacity at the expense of storage system performance, thus causing computational bottlenecks. Also, in an attempt to achieve increased processor count and storage capacity in large, powerful compute grids, designers have increased the density of individual compute nodes in these grids. The results are a denser distribution of processor cores, greater network bandwidth, and more memory—storage capacity—in a smaller footprint. Such large-scale grids are designed for multi-user/multi-function jobs, but are typically optimized for computational throughput. Thus, in large-scale grids, networked storage devices and shares often become performance bottlenecks. Among other problems, these networked storage devices are susceptible to a single user on a single NFS export commandeering the entire grid and storage subsystems. Thus, an effective method for managing process and storage traffic in networked storage systems is critical to improving grid-computing throughput and efficiency.

Consider a large computational example from the oil and gas industry. In this example, seismic data from several counties requires analysis. This processing effort results in the generation of millions of compute jobs, each one of which creates read and write requests in a centralized, networked storage system. Since some of the data sets being analyzed are interdependent, queuing systems tend to assign these interdependent compute tasks to the same processors, which in turn access the same physical storage device (e.g. a disk drive or share). This concentration of processes and storage requests creates a critical computational bottleneck. A distributed resource manager (DRM) undertakes the processes of queuing and scheduling tasks. The DRM checks the jobs in the queue, determines computation requirements, and assigns the tasks to processor and storage resources. However, such scheduling tends to result in the saturation of some processors and the underutilization of others. Further, due to the interdependence of the many data sets in this example, the running processes tend to access the same physical storage device, thus causing further resource contention and delay. Therefore, a method of queuing that takes into account both processor and storage utilization when scheduling tasks would be better able to distribute both tasks and storage requests, thus increasing overall processing performance.

In the disclosed concept, storage devices are polled to create a database of key performance metrics. The key performance metrics include, among others, network bandwidth and input-output operations per second. The database is a centralized, vendor-independent repository for metrics. The database permits the maintenance of unique thresholds for each storage share and for each storage device. The database also permits for a set point, or baseline of key metrics, in order to amortize thresholds for different storage models and storage functions. The database is updated based on job length; shorter poll intervals are used to obtain improved real-time information about compute grids with shorter job lengths. The database also provides for the inclusion of information on ignoring or enforcing rules for additional compute-infrastructure components. A network-attached rule engine that updates the database also performs the polling. The decision to submit a particular job is made by a queuing system master (QSM) which consults the customized rules given by the rule engine and bases the decision to permit a compute job to proceed on these customized and adaptable performance metrics. The application of specific queuing rules may be based on fairness, job priority, or an honor system. Queuing decisions may be made based on present storage system status, computational requirements, and/or job dependencies. For example, a job currently executing may force a pending job to wait if the pending job depends on the same data set as the executing job (e.g. precedence of operation). Conversely, a job that executes on another disk would be allowed to proceed. The QSM consults both the rule engine and the database of metrics in order to decide how best to execute a job. Each compute job may be evaluated at various times based on the storage-polling interval. Potential evaluation times include, among others, the time of job submission, before the job hits the queue; when the job waits in the queue for execution; and when the compute job is dispatched for execution on a compute grid (e.g. before the job executes). The database of metrics is flexible and may comprise a wide range of data, including, for example, the APIs and metrics provided by vendors, unique thresholds for each storage share and each storage device, a baseline of key metrics designed to amortize thresholds for differing storage models and functions, poll intervals in order to get real-time information for grids with smaller job lengths and to update the database based on job length, and ignore or enforce rules for additional infrastructure components. Such metrics permit task prioritization based on performance, network bandwidth, and storage bandwidth. Each compute job is tagged with a specific action after its evaluation, for example: allow execution, deprioritize, disallow, or suspend. Each job may be checked multiple times based on the storage-polling interval.

Compute jobs in the queue are typically prioritized in order to perform higher priority jobs before lower priority jobs. However the disclosed system may require higher priority jobs to wait, in some instances, in the queue while lower priority jobs are performed. One such instance may come when the data dependencies which require the accessing of the same data set on the same physical storage device by multiple processes appear. As a result of the pending status both higher priority jobs and lower priority jobs—and therefore processors—may remain idle. Thus, the QSM may reach farther down into the queue to retrieve smaller or lower priority jobs and schedule those jobs for execution. In this manner, greater computational efficiency may be realized by boosting overall system throughput.

The disclosed concept is based on storage-aware job scheduling. In embodiments, each job in the scheduler's queue is evaluated on an individual basis for job related parameters (dependencies, array, etc.) and for storage related dependencies. The job is then dispatched for execution based on policies implemented to manage the scheduling properties. Each storage device and network share is monitored for various features including CPU, memory, capacity, performance, type, function, and other custom parameters. Tags may represent critical boundary metrics for a storage system. These tags may be assigned different thresholds against which the scheduler may take action.

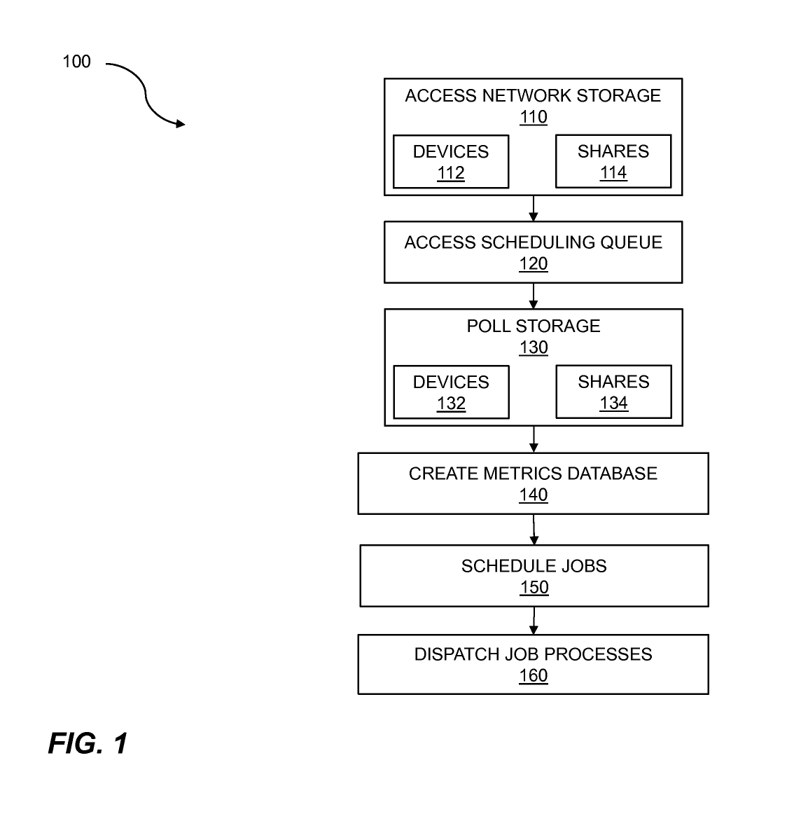

FIG. 1 is a flow diagram for storage-aware job scheduling. A flow 100 is described for a computer implemented scheduling method using dynamic storage-aware job scheduling. The flow 100 may comprise a computer-implemented method for job scheduling. Effective job scheduling is critical to the efficient operation of large multiprocessor systems such as grid computers. The purpose of job scheduling is to ensure that the jobs are executed efficiently based on priority, data availability, data dependencies, and the like. A job schedule must take into account availability of processors to execute the job, availability of storage for data handling, availability of data to be processed, and many other parameters. Many scheduling algorithms and heuristics exist which are based on throughput, latency (i.e. turnaround and response times), fairness, and wait times, among others. However, scheduling algorithms are notorious for assigning all of the high priority tasks in their queues to the fastest processors, thus saturating those processors while leaving other, perhaps slower, processors underutilized or, worse, idle. For example, lower priority jobs, or jobs which access data independent of the data being used by other high priority jobs, may remain in the queue unexecuted. Thus, scheduling approaches must become “smarter” than the current state-of-the-art. The algorithms must take into account the status of the processors, the status of the job queue, and the status of the storage system in order to efficiently schedule jobs for maximum system performance.

In addition to congestion of jobs due to levels of processor utilization, networked storage systems may also contribute to the backlog of jobs in the job queue. The backlog may be caused by a variety of limitations of a networked storage system including network bandwidth (e.g. a network connection to a networked storage system), data input/output bandwidth, storage configuration, and amount of local memory. Worse, because of data dependencies, multiple jobs being executed on multiple processors may try to access interdependent data stored on a single physical storage device or storage share. This latter storage situation results in overutilization of drives of the networked storage system while other drives may remain underutilized or idle. Further, lower priority jobs in the queue, or higher priority jobs which access independent data sets, may remain unexecuted. Thus, a scheduling approach which effectively assigns a range of jobs in the queue in such a way as to avoid processor saturation and underutilization, as well as avoiding networked storage system saturation and underutilization, is critical to multiprocessor efficiency.

The flow 100 begins with accessing a networked storage system 110. In embodiments, the networked storage system may be part of a large multiprocessing system. In other embodiments, the multiprocessing system may include grid computing. The networked storage system may comprise at least one of storage devices and storage shares. The networked storage system may be collocated with the multiprocessor system or may be remotely located. The networked storage system is accessed via a network connection. The networked storage system is comprised of various storage devices 112. The storage devices may include a variety of disk drives including, but not limited to, Serial ATA (SATA) disks, Serial Attached SCSI (SAS) disks, and solid-state drives (SSDs). In addition, the networked storage system may comprise storage shares 114. The storage shares 114 may include logical drives, disk partitions, NFS shares, and the like.

The flow 100 continues with accessing a scheduling queue 120 of pending job processes which use the networked storage system. In embodiments, the scheduling queue 120 may reside on a multiprocessor system, a dedicated processor, a networked processor, and the like. Jobs to be executed may be stored in a job queue 120. The job information stored in the queue may include key information about the jobs such as processor requirements, job priority, data sets required (e.g. data set or sets to be operated upon), data dependencies between and among jobs (e.g. order of operation, common data sets, etc.), and the like. Processing jobs to be executed may be added to the queue, released from the queue for execution, removed from the queue, and the like.

The flow 100 continues with polling the network storage system 130 to determine the status of members of the storage system. The status of key metrics pertaining to the networked storage system may be determined by such polling of the system. In embodiments, the networked storage system may be polled 130 to gauge the status of the various devices 132 comprising the storage system. The data gathered from the polling may include data about the utilization of these devices. In embodiments, the devices may include Serial ATA (SATA) disks, Serial Attached SCSI (SAS) disks, solid-state drives (SSDs), and the like. The networked storage system may be polled 130 to gauge the status of the various storage shares 134 comprising the storage system. In embodiments, the storage shares 134 may include logical drives, disk partitions, NFS shares, and the like. The polling may further comprise collecting parameters comprising CPU capabilities, memory capacity, maximum performance rate, percentage utilization, and the like.

The flow 100 continues with creating a database of metrics 140 describing the status of the members of the networked storage system. In embodiments, the database of metrics may be stored on the multiprocessor system, a dedicated processor, a networked processor, and the like. The database may comprise metrics describing the status of the members of the network storage system. In embodiments, the members of the networked storage system comprise storage devices and storage shares. In embodiments, the metrics gathered for a network device or network share may include features such as CPU, memory, capacity, performance, type, function, and other custom parameters.

The flow 100 continues with scheduling jobs 150. Job scheduling may comprise examining each job in the job queue to determine job related parameters such as priority, processing requirements, data requirements, data dependencies, and the like. In embodiments, a grid scheduler may accomplish the scheduling. A grid scheduler may be part of a grid computer, a networked device, and the like. In embodiments, a rules engine may be used in the scheduling by a grid scheduler. Scheduling jobs may consist of assigning jobs to specific processors, allocating specific storage devices and shares, and the like. The database of metrics may be used to determine which processors and which data storage devices and shares may be appropriate for a given task in the job queue. In embodiments, job scheduling may further comprise scheduling a subset of the job processes. The subset of jobs that may be scheduled may be determined based on priority, storage requirements, data dependencies, and other key parameters. For example, a subset of jobs may be scheduled based on the independence of the data sets operated upon by the processes. In embodiments, the scheduling may be based on job properties from the subset of the job processes. Typically a job with higher priority may be scheduled ahead of jobs with lower priority. In embodiments, the job process with lower priority may have different storage requirements from job processes with higher priority. The different storage requirements of the lower priority job may result from data independence of a lower priority job in comparison to a given higher priority job. Thus, under some circumstances, a lower priority job may be scheduled ahead of a higher priority job.

In embodiments, the scheduling may proceed as follows: each NFS module (e.g. network device or network share) may be monitored for various performance limiting parameters. The metrics may be maintained in a high performance database that may also keep historical information. Thus, the scheduler's responsibility may be to schedule or place jobs. The scheduler may intercept each job and check, using a database, the job for storage dependencies. The scheduler may then take various actions, including but not limited to submitting the job for execution or taking other actions if the job may not be submitted at a given time. Other actions may include, emailing the owner of a job that the job may be dependent on a network share has failed or is about to fail, holding back and/or changing priority of a job or jobs that may be dependent on a failing storage component, deleting a set of jobs that may be creating a high load on a network share, submitting (re-queuing) the job and emailing the administrator about a failing network share, and the like. In this manner, network shares of a multi-user, multi-product regression environment, for example, may be controlled.

The flow 100 continues with dispatching job processes 160. Dispatching job processes may comprise identifying available and capable processors, allocating storage devices and shares, and the like. In embodiments, the flow 100 may include dispatching job processes to a networked storage system based on the database of metrics describing the status of the members of the networked storage system. Job dispatching based on the database of metrics may avoid processor overutilization, processor underutilization, and the like. In embodiments, the dispatching of job processes may be further based on the storage requirements of the job processes. Job dispatching based on storage requirements may avoid storage device and share overutilization, device and share underutilization, network saturation, input/output saturation, and the like. In embodiments, the scheduling may comprise dispatching a job process with lower priority. Various steps in the flow 100 may be changed in order, repeated, omitted, or the like without departing from the disclosed inventive concepts. Various embodiments of the flow 100 may be included in a computer program product embodied in a non-transitory computer readable medium that includes code executable by one or more processors.

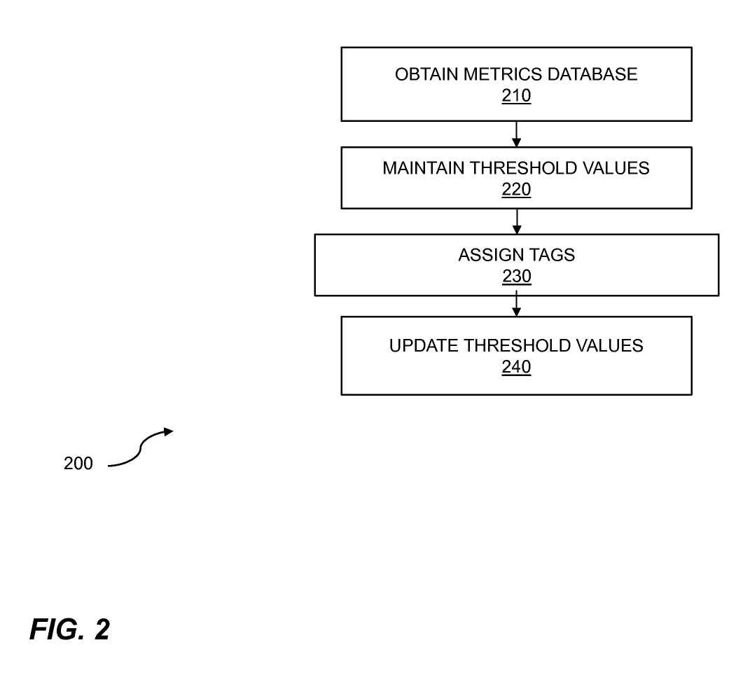

FIG. 2 is a flow diagram for metric and threshold usage. A flow 200 may continue from a previous flow 100. In some embodiments, the flow 200 may stand on its own and work from a pre-existing database to maintain metrics and threshold values. The flow 200 may include obtaining a metrics database 210. The metrics database 210 may be high performance to expedite data storage and retrieval. The metrics database may comprise a variety of metrics pertaining to a networked storage system, including information about network storage devices and network storage shares. Each network storage device and network share may be monitored for various metrics, comprising, in some embodiments, features such as CPU capacity and utilization, memory capacity and utilization, system performance, storage type, storage function, and the like. A pushing or pulling data collection process may gather the metric values which may pertain to a networked storage system. The metrics stored in the metrics database may comprise standard, vender-defined, or custom parameters and metrics. In embodiments, custom metrics may also be defined by an operator. A rules engine may access the metrics database. In embodiments, the scheduling may be based on the database of the metrics. Since a significant amount of data pertaining to a networked storage system may be stored in a metrics database, a search of the database may become time consuming. To speed searches of the metrics database, the database of metrics may include index-enabled values.

The flow 200 may continue with maintaining threshold values 220 for the members of the storage system. Members of a networked storage system may comprise network storage devices and network storage shares. A networked storage system may be optimized for storage volume instead of storage performance. In order for a networked storage system to function efficiently, threshold values may be set for key parameters. The threshold values may be maintained 220 in the database of the metrics. Threshold values may be maintained in a variety of forms including, for example, textual or numeric forms. A threshold value may be specific to a certain member of the storage system. For example, a value limiting utilization percentage to 85% may be set to prevent saturation of a network storage device or storage share. In embodiments, threshold values may be set for any key parameters pertaining to a networked storage system. In embodiments, the threshold value may include one of a group including storage limit, interface bandwidth limit, number of job processes accessing a storage member, and the like.

The flow 200 may continue with assigning tags 230 to threshold values to represent boundary metrics. Tags which are assigned may represent important boundary metrics for a network storage device, network storage share, and the like. In embodiments, tags may include data comprising the CPU utilization of a network share. For example, if a CPU of a given storage unit were highly utilized, then that CPU may not be able to execute its processing jobs effectively. Further, if the utilization of a given network share were to be high, e.g. 85%, then, as stated before, that network share would not be able to perform effectively. As a result, job processes and storage jobs may be suspended, deleted, delayed, re-queued, and the like.

The flow 200 may continue with updating threshold values 240. Updating threshold values may permit dynamic improvement to the effective scheduling of processing jobs. Since the performance of a multiprocessor system may be directly impacted by a mix of processing and storage tasks operating at a given point in time, updating threshold values may improve overall system performance. For example, if a particular processor were to approach or already be in saturation, then further scheduling of processes to that processor would be detrimental to overall processing efficiency. In order for assignment of tasks to processors and storage shares to be performed effectively, updating parameters and threshold values may be critical. In embodiments, the updating of the threshold values 240 may be based on a job process length. For example, if a processor were operating on a large processing job, then assigning further large processing jobs to that processor would be counterproductive. In embodiments, the flow may further comprise updating the threshold values 240 based on a status-polling interval. For example, increasing the rate of polling of storage devices and storage shares may provide additional, critical, information about the state of a networked storage device at that time. Such polling may yield more effective and more efficient schedules, thus boosting overall processing. Various steps in the flow 200 may be changed in order, repeated, omitted, or the like without departing from the disclosed inventive concepts. Various embodiments of the flow 200 may be included in a computer program product embodied in a non-transitory computer readable medium that includes code executable by one or more processors.

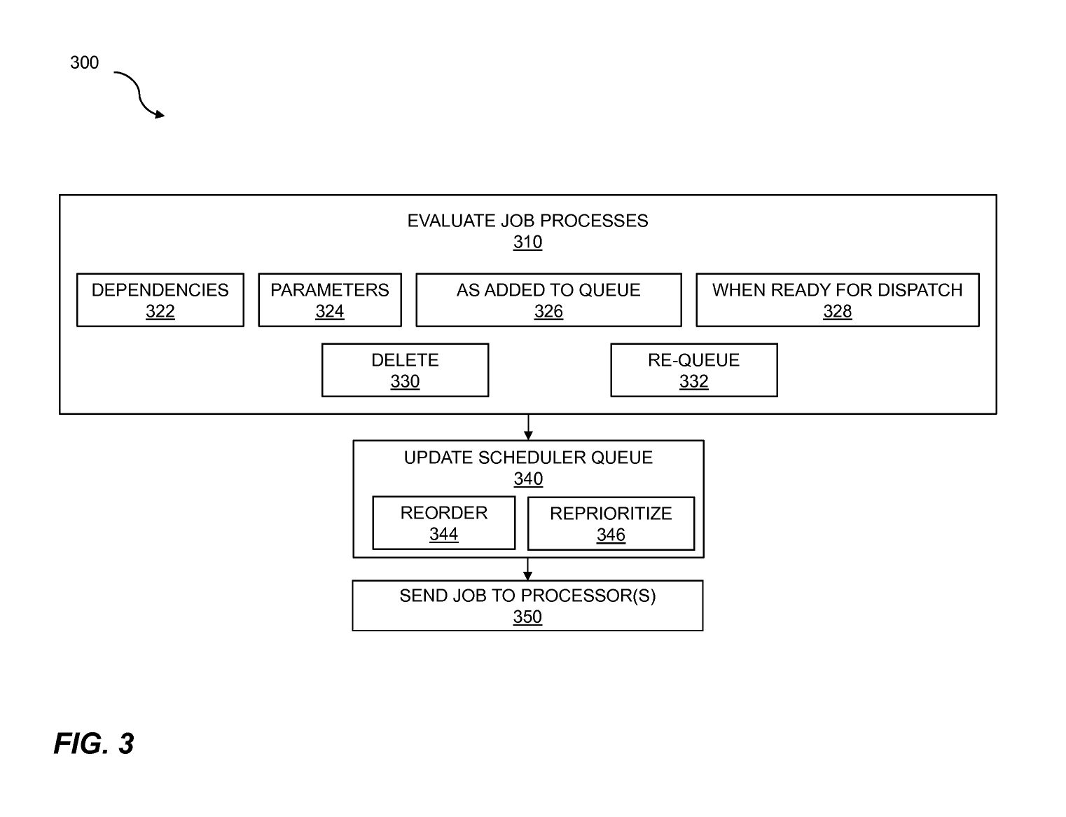

FIG. 3 is a flow diagram for job evaluation. A flow 300 may continue or be part of a prior flow 100. In some embodiments, the flow 300 may stand on its own and work from a preexisting queue of job processes. The flow 300 may continue or be part of a prior flow 200. In some embodiments, the flow 300 may stand on its own and work from a preexisting queue of job processes. The flow 300 may include evaluating job processes 310. In a multi-tenancy environment, a grid computer as an example, users and processes may compete for processors, storage devices and storage shares of the networked storage system. Job processes may be queued in order to schedule those jobs on processors and on the networked storage device. The jobs may be scheduled based on a number of criteria including, but not limited to, processor availability, storage availability, job priority, data set availabilities, data dependencies, and the like. In order to optimize performance in a grid environment, it is therefore necessary to optimize job processing and storage access. Evaluation of the job processes 310 may be performed in order to optimize execution of the jobs in the queue.

The flow 300 may further comprise evaluating for storage dependencies 322 a job process in the scheduling queue. Job processes in the queue may require access to various data sets in order to execute. For example, a job in the process queue may require access to a data set presently being operated upon by another process or processes. Similarly, a job in the process queue may require access to a data set which is independent of another process or processes.

The flow 300 may further comprise evaluating a job process in the scheduling queue for key parameters 324. The jobs to be processed may be evaluated based on a number of criteria including, but not limited to, processor availability, storage availability, job priority, data sets, data dependencies, and the like. For example, a process may have storage requirements which are particularly large, or other requirements which may complicate scheduling. In embodiments, the flow 300 may further comprise evaluating a job process 310 in the scheduling queue for storage related parameters.

The flow 300 may further comprise evaluating job processes 310 at various times before they may be dispatched for processing. In embodiments, job processes may be evaluated at the time the processes are added to the queue, while they remain in the queue, and at the point that they may be removed from the queue to be sent to a processor or processors. For example, the flow 300 may further comprise evaluating a job process at the time the job process is added to the queue 326. In this manner, various key attributes of the job may be examined in order to help determine priority, processing dependencies, data dependencies, and the like. The process job may also be evaluated while the job is in the queue. Depending on the polled status of storage elements of a networked storage system, a given drive or share may be at or over capacity.

The flow 300 may further comprise evaluating a job process when the job process is ready to be dispatched for execution 328. As mentioned previously, a process job ready for dispatch may be evaluated for a number of parameters including, for example, job priority, data dependencies, data independence, processing requirements, and the like. Thus, if processing or storage capacity is not currently available, for example, then the scheduler may revisit the queue to seek job processes which have data sets available. Similarly, lower priority jobs may be dispatched for execution if their data sets are available, and so on. If a job in a queue may not be executed at present for reasons mentioned or for other reasons, several courses of action may be taken. For example, a process job which may not be executed at present due to a problem or problems such as insufficient processing or storage capacity may be delayed. The flow 300 may further comprise deleting a job process 330 from the scheduling queue based on storage requirements of the job process. Such a deletion may allow the networked storage system, for example, to recover from a high utilization state. Other actions may be taken as well. In embodiments, the flow 300 may further comprise re-queuing 332 the job process which was deleted.

The flow 300 may continue with updating a scheduler queue 340. Job processes may have been placed into a queue via a variety of techniques. For example, job processes may have been added to a queue in the order in which the processes arrived. In another example, processing jobs may have been ordered by priority. Based on the evaluation or evaluations 310, job processes in the queue may be deleted, reordered, reprioritized, or otherwise altered. In embodiments, the flow 300 may further comprise updating an order within the scheduling queue based on at least one of storage-related parameters and storage dependencies. In one embodiment, the jobs in the process queue may be reordered 344. Job reordering may occur because of data dependencies, data availability, processor load, and the like. In another embodiment, jobs in the process queue may be reprioritized 346. For example, a job or jobs with lower priority may be promoted because the data set they require is independent of data sets required by higher order processes. In another example, lower priority jobs may be promoted because they have processing and/or storage requirements which may be met by currently available processors, storage devices and storage shares.

The flow 300 may continue with sending queued process jobs to be executed. In embodiments, the flow 300 may further comprise sending a job process to a processor 350. Based on data dependencies, processing requirements, and storage requirements, a process may be dispatched for execution where a job process is assigned to a processor for execution. Storage devices or storage shares may be allocated to the process based on process requirements and storage device and storage share availability. Various steps in the flow 300 may be changed in order, repeated, omitted, or the like without departing from the disclosed inventive concepts. Various embodiments of the flow 300 may be included in a computer program product embodied in a non-transitory computer readable medium that includes code executable by one or more processors.

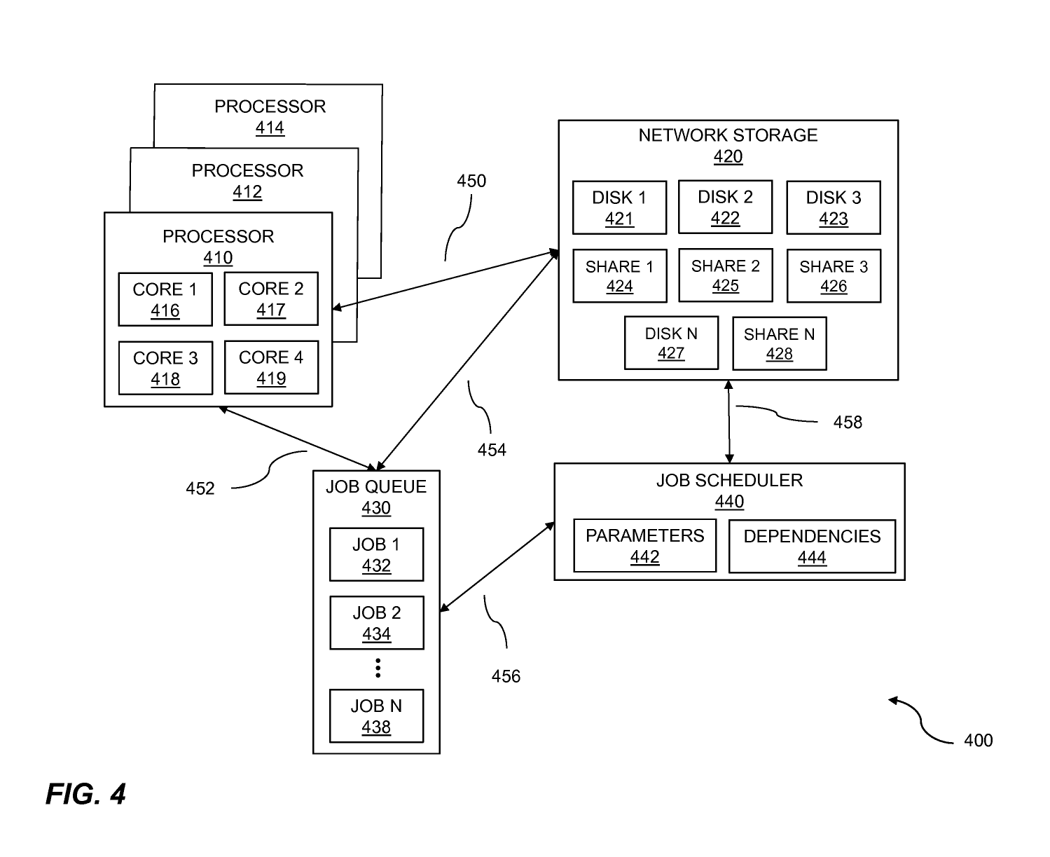

FIG. 4 is a diagram showing a large-scale storage system. The system 400 may comprise a computer-implemented method for job scheduling. In large computational environments such as grid computers, many processors may share networked storage systems. A networked storage system may comprise many storage devices and storage shares. Such large-scale grids are designed for multi-user/multi-function jobs, and may typically be optimized for computational throughput. A large multiprocessor system may connect to a networked storage system. A large multiprocessor system may comprise multiple processors, such as Processor 410, Processor 412, Processor 414, and the like. In embodiments, a multiprocessor system may be a grid computer. A grid computer may comprise fifty thousand processors or more. Each processor of a multiprocessor system may comprise multiple cores. For example, Processor 410 may comprise four cores such as Core 1 416, Core 2 417, Core 3 418, Core 4 419, and the like. Each core may be capable of processing one task or more simultaneously. Other processors such as Processor 412, Processor 414, and so on, may also possess multiple cores.

A system 400 may include accessing a networked storage system 420. Various processors, Processor 410, Processor 412, and Processor 414 for example, may connect to Network Storage 410 via a network connection 450. A network connection 450 may be a wired connection (e.g. Ethernet), a wireless connection (e.g. 802.11 Wi-Fi or Bluetooth™), or other appropriate networking technology. Networked Storage 420 may comprise any number of storage devices; for example disks, storage shares, NFS shares, and exports. Network Storage 420 may comprise Disk 1 421, Disk 2 422, Disk 3 423, and so on up to Disk N 427. In a similar manner, Network Storage 420 may comprise Share 1 424, Share 2 425, Share 3 426, and so on up to Share N 428. Network Storage 420 may combine only storage devices, only storage shares, or a combination of storage devices and storage shares. In embodiments, storage devices may be Serial ATA (SATA) disks, Serial Attached SCSI (SAS) disks, or solid-state drives (SSDs). In embodiments, storage shares may be NFS shares and exports, or other shared storage resources.

A system 400 may include accessing a scheduling queue 430 of pending job processes which use the network storage system. A queue may comprise one or more processing jobs awaiting execution. A scheduling queue of pending job processes may comprise one or more jobs, for example, Job 1 432, Job 2 434, and so on up to Job N 438. Any number of processing jobs may be stored in the job queue while pending processing. The queue may also comprise storage, and other similar, jobs pertaining to the processing jobs. A job queue 430 may connect 452 to multiple processors, for example Processor 410, Processor 412, Processor 414, and the like. A network connection 452 may be a wired connection (e.g. Ethernet), a wireless connection (e.g. 802.11 Wi-Fi or Bluetooth™), or any other appropriate networking technology. A network connection 452 may be implemented to transfer processing jobs in the job queue 430 to a core or cores of a processor or processors 410. A network connection 452 may be used to return processes to a queue. A job queue 430 may connect 454 to multiple storage devices and storage shares, for example Disk 1 421, Disk 2 422, Disk 3 423, and up to Disk N 427, and for example, Share 1 424, Share 2 425, Share 3 426, and up to Share N 428, and the like. A network connection 454 may be a wired connection (e.g. Ethernet), a wireless connection (e.g. 802.11 Wi-Fi and Bluetooth™), or other appropriate networking technology. A network connection 454 may be implemented to transfer storage jobs in the job queue 430 to a disk or disks, or a share or shares of a networked storage device. A network connection 454 may be used to return storage processes to a queue. A job queue 430 may connect 456 to a job scheduler 440. A network connection 456 may be a wired connection, (e.g. Ethernet), a wireless connection, (e.g. 802.11 Wi-Fi and Bluetooth™), or other appropriate networking technology. A network connection 456 may be implemented to transfer scheduling information about jobs in a job queue.

A system 400 may include a job scheduler 440. A job scheduler 440 may assign jobs in the job queue 430 to a core or cores of a processor or processors 410, and may allocate a storage device or devices, and a storage share or shares 420 to the jobs. A job scheduler 440 may connect to a job queue 430 as described above. Data dependencies 444 between and among jobs in the job queue 430 may be determined. For example, if a job waiting in the job queue requires a data set or sets currently being used by a job or jobs presently executing, then the pending job must wait for the required data sets to become available. Similarly, if a job waiting in the job queue requires a data set or sets which are available for processing, then that job may be sent for processing. A job scheduler may connect 458 to multiple storage devices and storage shares, for example Disk 1 421, Disk 2 422, Disk 3 423, up to Disk N 427. The scheduler might also connect to Share 1 424, Share 2 425, Share 3 426, up to Share N 428 and the like. A network connection 456 may be a wired connection, (e.g. Ethernet), a wireless connection, (e.g. 802.11 Wi-Fi and Bluetooth™), or other appropriate networking technology. The system 400 may include polling the networked storage system to determine the status of members of the storage system. A network connection 456 may be implemented to measure key parameters 442 of the storage devices and storage shares of a networked storage device 420. For example, parameters measured may include various features of a network storage device or network share such as CPU, memory, capacity, performance, type, function, and other custom parameters. Other parameters which may be measured may include percent utilization of a storage device or storage share, network utilization, and the like. The system 400 may include creating a database of metrics describing the status of members of a networked storage system. Parameters 442 and dependencies 444 may be used to determine allocation of a processor or processors, allocation of a disk or disks, or a share or shares, to a job or jobs in a job queue. The system 400 may include dispatching job processes to a networked storage system based on a database of metrics describing a status of members of a networked storage system. Since a wide range of computing applications may use a networked storage system, storage performance tuning may be necessary in order for specific computational tasks to function at maximum efficiency. For example, allocation of processors and storage may be determined such that compute jobs do not consume all available resources, thus starving other jobs of their required resources. Also, allocation may be determined such that jobs in the job queue and storage tasks accessing networked storage do not saturate some processors or memory devices or shares while leaving other processors or memory devices or shares underutilized or idle.

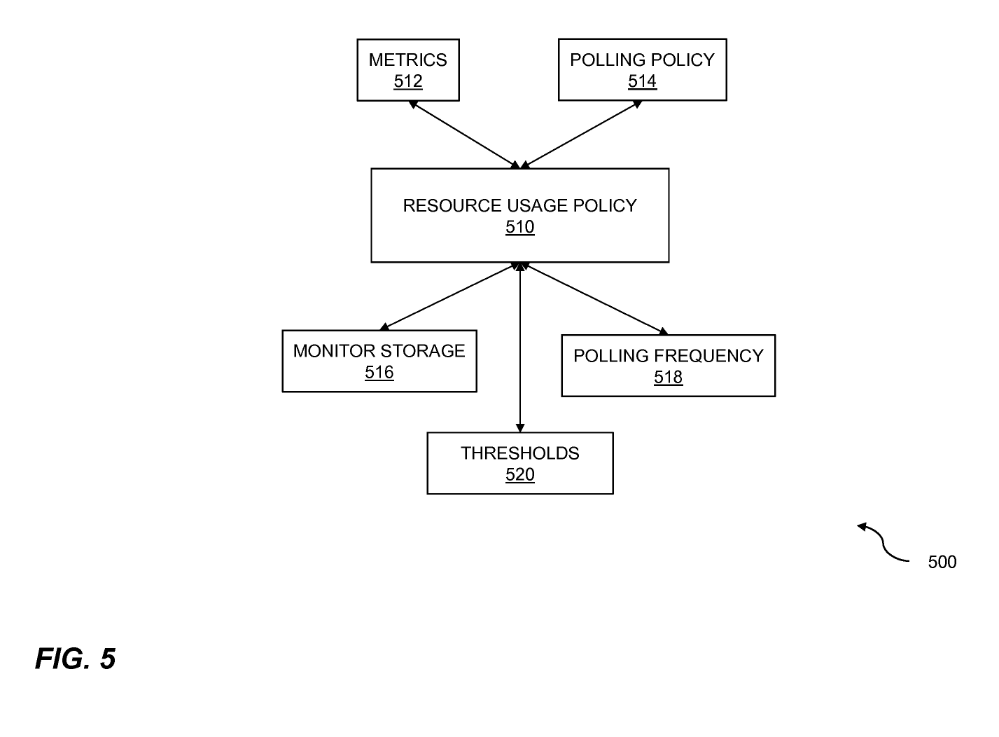

FIG. 5 is a diagram showing resource usage policy 500. A large parallel processing system such as a grid computer may include accessing a networked storage system. Sharing, or multi-tenancy, in a grid computer system presents several advantages including efficiency, lower cost, and increased accessibility. But, such sharing may also introduce significant unpredictability with respect to job processing. Unpredictable job processing may result from the mix of jobs being processed and the impact of those jobs on a networked storage system's utilization and resulting efficiency. In order to improve the efficiency of a networked storage system, a resource usage policy 510 may be introduced. A resource usage policy may comprise rules for usage, and may be based on a variety of parameters and actions. The scheduling of process jobs may be based on a policy or policies, and may include accessing a scheduling queue of pending job processes which use the networked storage system. In embodiments, a resource usage policy may comprise a computer-implemented method for job scheduling.

A resource usage policy may include creating a database of metrics describing the status of the members of the network storage system 512. In embodiments, the dispatching of job processes to the network storage system may be based on the database of metrics describing the status of the members of the network storage system. The metrics measured may comprise network storage device and network share features including CPU, memory, capacity, performance, type, function and the like. Metrics may also include custom parameters which may be specified by a given vendor or may be user defined. A resource usage policy may also comprise a polling policy 514. A polling policy may describe which storage devices and storage shares may be monitored 516 for capability, utilization, and the like. Monitoring storage may include polling the network storage system to determine the status of members of the storage system. In embodiments, the monitoring of storage devices and storage shares may determine a percentage of utilization of a storage device or storage share. For example, if the utilization of a network share were near 85%, then that share may not be able to perform at full capacity. A resource usage policy may also comprise a polling frequency 518. A polling frequency may determine how often storage devices and storage shares may be monitored. Various thresholds 520 may be set with respect to various metrics and other parameters that may be determined for a networked file system. Such thresholds may be used to determine whether a job may be submitted to a processor, or whether a processor, storage device, or storage share may be near failure. Thresholds, when met or exceeded, may also trigger various actions. In embodiments, an email may be sent to a job owner if a job which is dependent on a network storage device or network storage share is failing, is about to fail, or has failed. In other embodiments, other actions may be taken as a result of a threshold or thresholds being met: holding back jobs, rescheduling jobs, alerting systems administrators to pending or immanent failures, and the like.

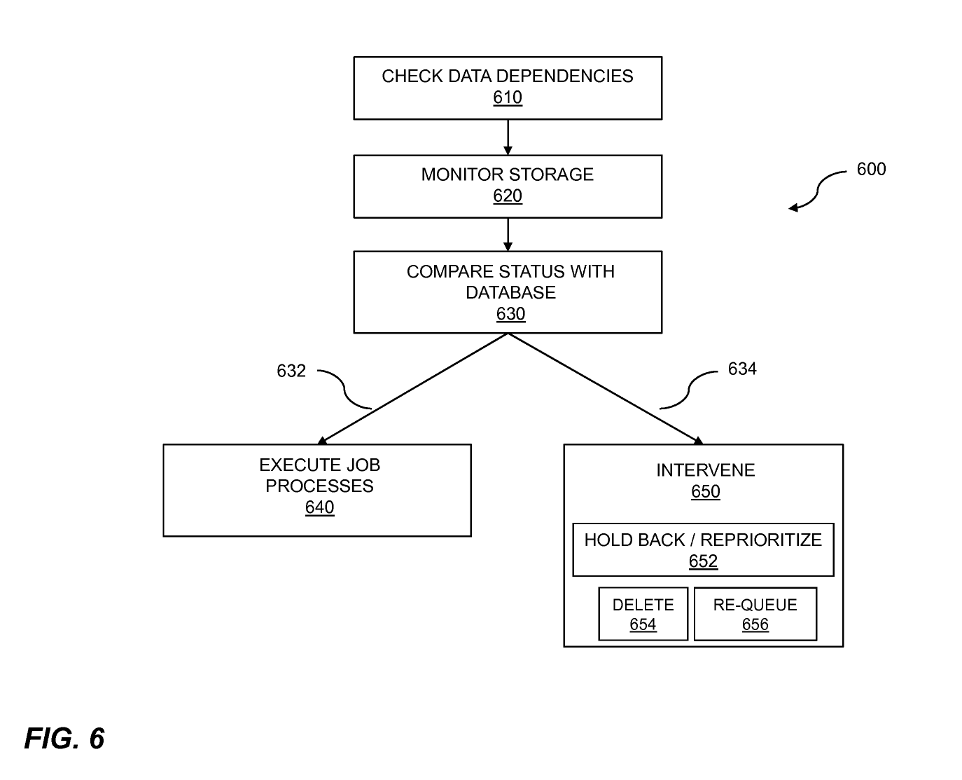

FIG. 6 is a flow illustrating scheduling. Processing a job may require that various system resources be assigned to that job. System resources may include a processor or processors, available storage resources, available data sets, and the like. The flow 600 may begin with checking data dependencies 610 of a job. The data upon which a job operates may be operated upon by one or more other jobs. So, if another job is presently operating upon a given data set, then the job that is pending execution may need to wait until the prior job has completed. A job may require data which is dependent of other process jobs. If so, a job may need to delay until the data which it requires is available. The flow 600 may continue with monitoring storage 620. In embodiments, the monitoring of storage may comprise collecting metrics pertaining to features of a network storage device or network share. In embodiments, the features of a network storage device or network storage share may include CPU, memory, capacity, performance, type, function, and other custom parameters. The flow 600 may continue with comparing the status of a networked storage system comprising network storage devices and network storage shares with a database of metrics 630. In embodiments, a rule engine which understands real-time performance capacities of storage may consult the database of metrics 630. A rule engine may then facilitate job scheduling through a Grid Scheduling Master (GSM). Based on the recommendation of the rule engine, a GSM may choose to submit a process job for execution 632, or choose to intervene with job execution 634. If the process job is submitted for execution 632, then a processor or processors and storage may be allocated to execute job processes 640. In embodiments, a rule engine and GSM may yield the best possible process turnaround by selecting a highly efficient schedule. If a job process is not submitted for execution because of a determination by a rule engine that the job may not be executed at a given point, then a scheduler may intervene 650. Intervention may take several forms. In one embodiment, a job process simply may be cached for later execution, effectively holding back the task for later execution or reprioritization 652. In another embodiment, a job may simply remain in a queue until storage devices and storage shares no longer have any processing issues. In embodiments, intervention may further comprise deleting a job process 654 from the scheduling queue based on storage requirements of the job process. In other embodiments, the flow may further comprise re-queuing the job process 656 which was deleted. A processing job may be removed from a processor or processors because the job is causing processing difficulties. In this situation, the job may be re-queue for later execution when the processor (or processors) and the network storage devices and network storage shares are no longer experiencing difficulties. Various steps in the flow 600 may be changed in order, repeated, omitted, or the like without departing from the disclosed inventive concepts. Various embodiments of the flow 600 may be included in a computer program product embodied in a non-transitory computer readable medium that includes code executable by one or more processors.

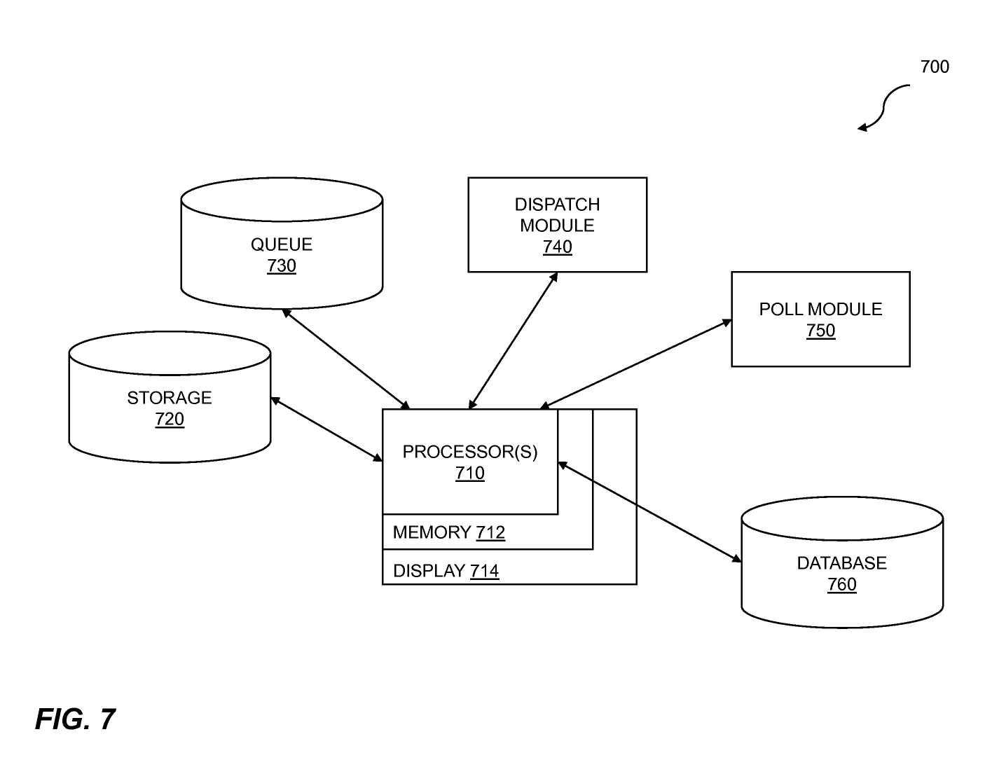

FIG. 7 is a system diagram for dynamic storage-aware job scheduling. In embodiments, the computer system 700 for dynamic storage-aware job scheduling may comprise one or more processors 710, a network storage system 720, a queue 730, a dispatch module 740, a poll module 750, and a database, 760. In at least one embodiment, the one or more processors may accomplish the dispatch and polling functions. The one or more processors may be coupled to the memory 712 which stores instructions, system support data, intermediate data, analysis, and the like. The one or more processors 710 may be coupled to an electronic display 714. The electronic display 714 may be any electronic display, including but not limited to, a computer display, a laptop screen, a net-book screen, a tablet computer screen, a cell phone display, a mobile device display, a remote with a display, a television, a projector, or the like.

The one or more processors 710, when executing the instructions which are stored, may be configured to access a network storage system 720. The storage system information may contain various types of information about a networked storage system, including features such as CPU, memory, capacity, performance, type, function, and other custom parameters. The storage system information may also comprise threshold values, assigned to the tags, which may permit or may otherwise allow job scheduling.

The one or more processors 710, when executing the instructions which are stored, may be configured to access a scheduling queue 730 of pending job processes which use the network storage system. The scheduling queue 730 may contain job processes which are pending execution. The jobs in the queue may require processing and storage resources in order to be executed. Jobs within the queue may be ordered based on job priority, data dependencies, data independence, and the like. In embodiments, job requirements may include data sets, data dependencies, processing requirements, and the like. Jobs within the queue may be submitted for execution, reordered, delayed, re-queued, and the like.

The one or more processors 710, when executing the instructions which are stored, may be configured to dispatch 740 job processes to the network storage system based on the database of metrics describing the status of the members of the network storage system. Jobs within the queue may be examined to determine what processing and storage capabilities are required by a given job. Based on a status of a networked storage system (e.g. metrics), priority of a given job, resources required to execute a given job, and the like, a job may be dispatched for processing. For example, if polling performed subsequent to dispatching of a given job for execution were to indicate that a process may be overburdening a processor, storage device, storage share, and the like, the job may be suspended or re-queued in order that the storage device or storage share may be allowed to recover from the overloading conditions.

The one or more processors 710, when executing the instructions which are stored, may be configured to poll 750 the network storage system to determine the status of members of the storage system. Due to a multi-tenancy nature of a networked storage system, various users and processes may be competing for processor and storage device resources. A polling module or device 750 may be networked in order to gauge the status of key features of the storage device or devices. The key features polled may include CPU capacity, memory, processing and storage capacity, performance, processor and storage type, functionality, custom parameters, and the like. The key features that may be polled may be accessed as part of scheduling and dispatching processes.

The one or more processors 710, when executing the instructions which are stored, may create a database 760 of metrics describing the status of the members of the network storage system. Data pertaining to a status of a networked storage system may be stored in a database 760. The data stored in a database may be index-enabled in order to enable rapid data storage and retrieval. The data which may be stored in the database may include metrics describing the key features of the storage system including CPU capability, memory, processing and storage capacity, performance, processor and storage type, function, custom parameters, and the like. A rule engine, as part of the scheduling and dispatching processes, may consult the database.

The computer system 700 for dynamic storage-aware job scheduling may comprise a computer program product with code for accessing a networked storage system embodied in a non-transitory computer-readable medium. The computer program product may include but is not limited to: code for accessing a scheduling queue of pending job processes which use the networked storage system; code for polling the networked storage system to determine the status of members of the storage system; code for creating a database of metrics describing the status of the members of the networked storage system; and code for dispatching job processes to the networked storage system based on the database of metrics describing the status of the members of the networked storage system.

Each of the above methods may be executed on one or more processors on one or more computer systems. Embodiments may include various forms of distributed computing, client/server computing, and cloud based computing. Further, it will be understood that the depicted steps or boxes contained in this disclosure's flow charts are solely illustrative and explanatory. The steps may be modified, omitted, repeated, or re-ordered without departing from the scope of this disclosure. Further, each step may contain one or more sub-steps. While the foregoing drawings and description set forth functional aspects of the disclosed systems, no particular implementation or arrangement of software and/or hardware should be inferred from these descriptions unless explicitly stated or otherwise clear from the context. All such arrangements of software and/or hardware are intended to fall within the scope of this disclosure.

The block diagrams and flowchart illustrations depict methods, apparatus, systems, and computer program products. The elements and combinations of elements in the block diagrams and flow diagrams, show functions, steps, or groups of steps of the methods, apparatus, systems, computer program products and/or computer-implemented methods. Any and all such functions—generally referred to herein as a “circuit,” “module,” or “system”—may be implemented by computer program instructions, by special-purpose hardware-based computer systems, by combinations of special purpose hardware and computer instructions, by combinations of general purpose hardware and computer instructions, and so on.

A programmable apparatus which executes any of the above mentioned computer program products or computer-implemented methods may include one or more microprocessors, microcontrollers, embedded microcontrollers, programmable digital signal processors, programmable devices, programmable gate arrays, programmable array logic, memory devices, application specific integrated circuits, or the like. Each may be suitably employed or configured to process computer program instructions, execute computer logic, store computer data, and so on.

It will be understood that a computer may include a computer program product from a computer-readable storage medium and that this medium may be internal or external, removable and replaceable, or fixed. In addition, a computer may include a Basic Input/Output System (BIOS), firmware, an operating system, a database, or the like that may include, interface with, or support the software and hardware described herein.

Embodiments of the present concept are neither limited to conventional computer applications nor the programmable apparatus that run them. To illustrate: embodiments could include an optical computer, quantum computer, analog computer, or the like. A computer program may be loaded onto a computer to produce a particular machine that may perform any and all of the depicted functions. This particular machine provides a means for carrying out any and all of the depicted functions.

Any combination of one or more computer readable media may be utilized including but not limited to: a non-transitory computer readable medium for storage; an electronic, magnetic, optical, electromagnetic, infrared, or semiconductor computer readable storage medium or any suitable combination of the foregoing; a portable computer diskette; a hard disk; a random access memory (RAM); a read-only memory (ROM), an erasable programmable read-only memory (EPROM, Flash, MRAM, FeRAM, or phase change memory); an optical fiber; a portable compact disc; an optical storage device; a magnetic storage device; or any suitable combination of the foregoing. In the context of this document, a computer readable storage medium may be any tangible medium that can contain or store a program for use by or in connection with an instruction execution system, apparatus, or device.

It will be appreciated that computer program instructions may include computer executable code. A variety of languages for expressing computer program instructions may include without limitation C, C++, Java, JavaScript™, ActionScript™, assembly language, Lisp, Perl, Tcl, Python, Ruby, hardware description languages, database programming languages, functional programming languages, imperative programming languages, and so on. In embodiments, computer program instructions may be stored, compiled, or interpreted to run on a computer, a programmable data processing apparatus, a heterogeneous combination of processors or processor architectures, and so on. Without limitation, embodiments of the present concept may take the form of web-based computer software, which includes client/server software, software-as-a-service, peer-to-peer software, or the like.

In embodiments, a computer may enable execution of computer program instructions including multiple programs or threads. The multiple programs or threads may be processed approximately simultaneously to enhance utilization of the processor and to facilitate substantially simultaneous functions. By way of implementation, any and all methods, program codes, program instructions, and the like described herein may be implemented in one or more threads which may in turn spawn other threads, which may themselves have priorities associated with them. In some embodiments, a computer may process these threads based on priority or other order.

Unless explicitly stated or otherwise clear from the context, the verbs “execute” and “process” may be used interchangeably to indicate execute, process, interpret, compile, assemble, link, load, or a combination of the foregoing. Therefore, embodiments that execute or process computer program instructions, computer-executable code, or the like may act upon the instructions or code in any and all of the ways described. Further, the method steps shown are intended to include any suitable method of causing one or more parties or entities to perform the steps. The parties performing a step, or portion of a step, need not be located within a particular geographic location or country boundary. For instance, if an entity located within the United States causes a method step, or portion thereof, to be performed outside of the United States then the method is considered to be performed in the United States by virtue of the causal entity.

While the invention has been disclosed in connection with preferred embodiments shown and described in detail, various modifications and improvements thereon will become apparent to those skilled in the art. Accordingly, the forgoing examples should not limit the spirit and scope of the present invention; rather it should be understood in the broadest sense allowable by law.

What is claimed is:

1. A computer-implemented method for job scheduling comprising:
accessing a network storage system;
accessing a scheduling queue of pending job processes which use the network storage system;
polling the network storage system to determine status of members of the network storage system;
creating a database of metrics describing the status of the members of the network storage system; and
dispatching job processes to the network storage system based on the database of metrics describing the status of the members of the network storage system.

2. The method of claim 1 wherein the dispatching of job processes is further based on storage requirements of the job processes.

3. The method of claim 1 further comprising scheduling a subset of the job processes.

4. The method of claim 3 wherein the scheduling is based on job properties from the subset of the job processes.

5. The method of claim 3 wherein the scheduling is based on the database of the metrics.

6. The method of claim 3 wherein the scheduling comprises dispatching a job process with lower priority.

7. The method of claim 6 wherein the job process with lower priority has different storage requirements from job processes with higher priority.

8. The method of claim 1 further comprising maintaining threshold values for the members of the network storage system.

9. The method of claim 8 wherein the threshold values are maintained in the database of the metrics.

10. The method of claim 8 wherein a threshold value from the threshold values is specific to a certain member of the network storage system.

11. The method of claim 8 wherein the threshold values includes one or more of a group including storage limit, interface bandwidth limit, number of job processes accessing a storage member.

12. The method of claim 8 further comprising updating the threshold values based on a job process length.

13. The method of claim 8 further comprising updating the threshold values based on a status-polling interval.

14. The method of claim 13 wherein the scheduling is accomplished by a grid scheduler.

15. The method of claim 8 further comprising assigning tags to threshold values to represent boundary metrics.

16. The method of claim 15 wherein the tags include data comprising CPU percentage utilization of a network share.

17. The method of claim 8 wherein a rules engine is used in the scheduling by a grid scheduler.

18. The method of claim 1 further comprising evaluating a job process in the scheduling queue for storage related parameters.

19. The method of claim 1 further comprising evaluating a job process in the scheduling queue for storage dependencies.

20. The method of claim 1 further comprising updating an order within the scheduling queue based at least one of storage related parameters and storage dependencies.

21. The method of claim 1 further comprising sending a job process to a processor.

22. The method of claim 1 further comprising evaluating a job process at a time the job process is added to the scheduling queue.

23. The method of claim 1 further comprising evaluating a job process when the job process is ready to be dispatched for execution.

24. The method of claim 1 further comprising deleting a job process from the scheduling queue based on storage requirements of the job process.

25. The method of claim 23 further comprising re-queuing the job process which was deleted.

26. The method of claim 1 wherein the network storage system comprises at least one of storage devices and storage shares.

27. The method of claim 1 wherein the database of metrics includes index-enabled values.

28. The method of claim 1 wherein the polling further comprises collecting parameters comprising CPU capabilities, memory capacity, maximum performance rate, or percentage utilization.

29. A computer system with job scheduling comprising:
a memory which stores instructions;
one or more processors coupled to the memory wherein the one or more processors are configured to:
access a network storage system;
access a scheduling queue of pending job processes which use the network storage system;
poll the network storage system to determine status of members of the network storage system;
create a database of metrics describing the status of the members of the network storage system; and
dispatch job processes to the network storage system based on the database of metrics describing the status of the members of the network storage system.

30. A computer program product embodied in a non-transitory computer readable medium for job scheduling comprising:
code for accessing a network storage system;
code for accessing a scheduling queue of pending job processes which use the network storage system;
code for polling the network storage system to determine status of members of the network storage system;
code for creating a database of metrics describing the status of the members of the network storage system; and
code for dispatching job processes to the network storage system based on the database of metrics describing the status of the members of the network storage system.
